(19) United States
(12) Patent Application Publication
(10) Pub. No.: US 2010/0178634 A1
(43) Pub. Date: Jul. 15, 2010

(54) DENTAL SANDING STRIP

(76) Inventor: Wendy Dralus, Bradenton, FL (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/687,177

(22) Filed: Jan. 14, 2010

Related U.S. Application Data
(60) Provisional application No. 61/144,538, filed on Jan. 14, 2009.

(51) Int. Cl. A61C 15/04

(52) U.S. Cl. 433/142; 433/216

(57) ABSTRACT

An improved dental sanding strip for removing material between the teeth is provided. The dental sanding strip includes a lead portion extending from one end of the dental sanding strip to facilitate the insertion of the strip into the space between the teeth. The dental sanding strip is an elongated strip of film having a first end and a second end. The first end having an abrasive portion and the second end having a holding portion. A lead portion extends from the first end, the area having the abrasive portion. The lead portion is affixed to the first end in a suitable manner such as with adhesive or by heat welding. The first end of the dental sanding strip is tapered toward the lead portion providing a gradual transition from the lead portion to the full width dental sanding strip. The lead portion of the dental sanding strip is inserted between the teeth by first inserting a free end of the lead portion into the space between the teeth. The dentist then grasps the lead portion and pulls the lead portion thereby permitting the abrasive portion of the dental sanding strip to contact the area on the tooth to be removed. The dentist may then manipulate the dental sanding strip to remove any unwanted material between the teeth. The dentist uses a back-and-forth motion, or a circular motion, to remove the unwanted material between the teeth.

### CROSS-REFERENCE TO RELATED APPLICATIONS

This application claims priority of U.S. Provisional Patent Application Ser. No. 61/144,538 filed Jan. 14, 2009, which is incorporated herein by reference.

### FIELD OF THE INVENTION

The present invention relates to dental equipment. More particularly, this invention relates to a method and apparatus for removing unwanted material between teeth.

### BACKGROUND OF THE INVENTION

After filling a tooth with composite, the dentist uses tools to shape and form the filling or amalgam material to provide the desired shape and smoothness. However, when filling a tooth which is in contact with another tooth, such as a distal occlusal (DO) or a mesial occlusal (MO), frequently a portion of filling material overhangs interproximately or between the teeth. Typically, the dentist uses a sanding strip to remove the overhanging material. The sanding strip is an elongated strip of material having an abrasive surface portion which is inserted in the gap between the teeth and then moved back and forth in a sawing motion against the unwanted material to remove the unwanted material. However, it is often difficult to get the sanding strip into the space between the teeth. Accordingly, it is desirable to provide an improved sanding strip which is easily used by the dentist.

### SUMMARY OF THE INVENTION

An improved dental sanding strip for removing material between the teeth is provided. The dental sanding strip includes a lead portion extending from one end of the dental sanding strip to facilitate the insertion of the strip into the space between the teeth. The dental sanding strip is an elongated strip of film having a first end and a second end. The first end having an abrasive portion and the second end having a holding portion. The lead portion extends from the first end, the area having the abrasive portion. The lead portion is affixed to the First end in a suitable manner such as with adhesive or by heat welding. The first end of the dental sanding strip is tapered toward the lead portion providing a gradual transition from the lead portion to the full width dental sanding strip. The lead portion of the dental sanding strip is inserted between the teeth by first inserting a free end of the lead portion into the space between the teeth. The dentist then grasps the lead portion and pulls the lead portion thereby permitting the abrasive portion of the dental sanding strip to contact the area on the tooth to be removed. The dentist may then manipulate the dental sanding strip to remove any unwanted material between the teeth. The dentist uses a back-and-forth motion, or a circular motion, to remove the unwanted material between the teeth.

### BRIEF DESCRIPTION OF THE DRAWINGS

FIG. 1 is a perspective view of the prior art;

FIG. 2 is a perspective view of the insertion of the dental sanding strip between teeth;

FIG. 3 is a side view of the dental sanding strip with lead portion;

FIG. 4 is a cross-sectional view of section 4-4 as shown in FIG. 2; and

FIG. 5 depicts a perspective view of the sawing motion of the dental sanding strip.

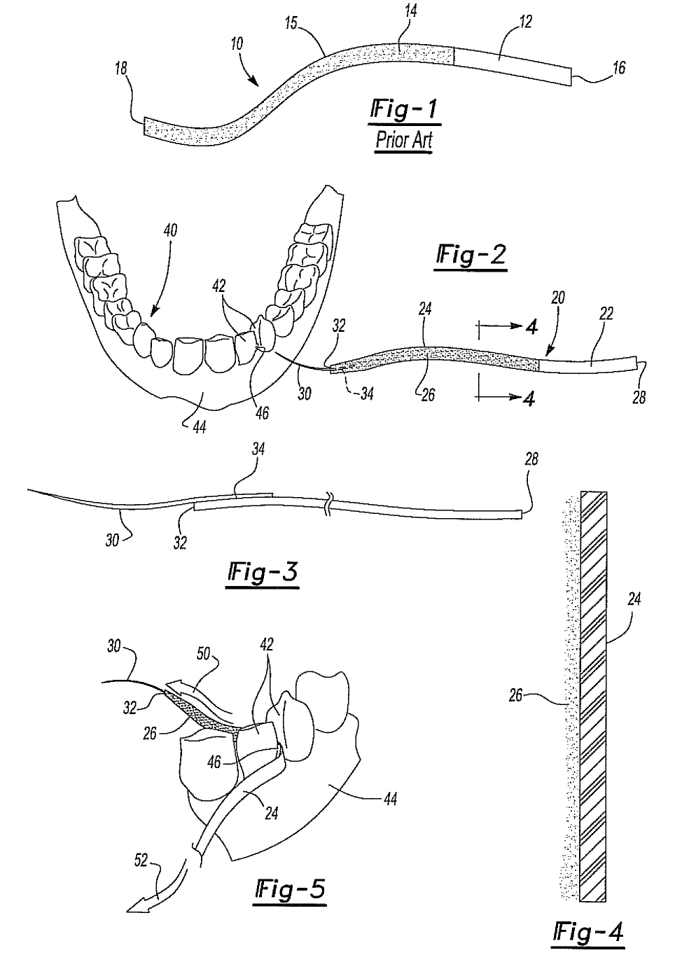

### DETAILED DESCRIPTION OF THE INVENTION

The present invention provides a dental sanding strip including a lead portion extending from one end of the dental sanding strip to facilitate the insertion of the dental sanding strip into the space between the teeth. The dental sanding strip includes an abrasive portion, a gripping portion, and the lead portion.

A dental sanding strip 10 is commonly used by dentists to remove overhanging material, or any unwanted material, on a tooth. A dental sanding strip 10 includes a first end 18 and a second end 16. The dental sanding strip 10 further includes an abrasive portion 14 and a gripping portion 12. A back surface 15 is smooth so as to not disrupt adjacent teeth. The first end 18 is inserted between teeth to remove any unwanted material. However, it is often difficult to insert the dental sanding strip 10 into the space between the teeth.

The present invention provides a dental sanding strip 20 having a first end 32 and a second end 28, as shown by FIG. 2. The first end 32 includes an abrasive portion 26. The second end 28 includes a gripping portion 22. Furthermore, the dental sanding strip 20 includes a back side 24. The back side 24 is smooth so as to not disturb adjacent teeth. The dental sanding strip further includes a lead portion 30, or elongated filament, affixed to the first end 32. The lead portion 30 is affixed to the first end 32 by a connection 34. The connection 34 may be an adhesive or by heat welding or other suitable attachment means. The first end 32 of the dental sanding strip 20 is tapered toward the lead portion 30 so that there is a gradual transition from the lead portion 30 to the full width of the dental sanding strip 20.

The dental sanding strip 20 is an elongated strip of film such as Mylar. The strip is approximately 7 inches long and has a width of between 0.125 inches and 0.25 inches. The abrasive portion 26 is approximately 4 inches long.

The lead portion 30 extends from the first end 32. The lead portion 30 is an elongated filament extending from the first end 32. The lead portion 30 is an elongated flexible member. The lead portion 30 is also described as an elongated, flexible filament with high resilience and flexibility allowing for easy manipulation and maneuverability between the teeth 42. The lead portion 30 is formed of a suitable material which retains its shape but has some flexibility. An acceptable material is a plastic or nylon filament, or any resilient, flexible material. The lead portion 30 may be of a material similar to a heavy weight floss, or heavy weight fishing line. The lead portion 30 is approximately 1 inch long. The lead portion has a circular cross section and may optionally have a rectangular, square or triangular cross section. The lead portion 30 extends from the first end 32, and may be affixed to the dental sanding strip 20 at the abrasive portion 26 or at the smooth side 24. The lead portion 30 is adapted to facilitate insertion of the dental sanding strip 20, thereby aiding the dentist in removing any unwanted material.

The dental sanding strip 20 is intended for use in a human mouth 40. The human mouth 40 includes teeth 42 and a gum line 44. The dental sanding strip 20 is required when a tooth 42 includes an overhang 46, or other unwanted material such as plaque. The lead portion 30 of the dental sanding strip 20 is inserted between the teeth 42. The lead portion 30 which extends from the first end 32 of the dental sanding strip 20 facilitates the insertion of the dental strip 20 into the space between the teeth 42. Once the lead portion 30 passes between the teeth 42, the lead portion 30 is grasped by the dentist and the abrasive portion 26 may be then pulled into the area between the teeth 42 and manipulated to remove any unwanted material between the teeth 42 such as the overhang 46. A back-and-forth or sawing motion is shown by illustrative arrows 50 and 52. The sanding strip 20 is pulled back-and-forth, or in a circular motion, until the overhang material 46, or other unwanted material, is removed.

Having thus described my invention, in reference to the preferred embodiment, it is apparent that there may be modifications or variations of the invention which are within the scope of the invention. There are many different materials which may be used as the lead, and the dental sanding strip may be in one of a variety of different configurations.

1. A dental sanding strip for removing material between teeth, the sanding strip comprising:
an elongated strip having a first end and a second end, the first end having an abrasive portion, the second end having a holding portion; and
an elongated filament extending from the first end of the elongated strip, the elongated filament affixed to the elongated strip;
wherein the elongated filament facilitates insertion of the elongated strip into a space between teeth.

2. The dental sanding strip of claim 1, wherein the elongated filament is flexible.

3. The dental sanding strip of claim 1, wherein the elongated filament has a circular cross section.

4. The dental sanding strip of claim 1, wherein the first end is tapered.

5. The dental sanding strip of claim 1, wherein the elongated filament is heat welded to the elongated strip.

6. The dental sanding strip of claim 1, where the elongated filament is glued to the elongated strip.

7. The dental sanding strip of claim 1, wherein the elongated strip includes a first surface and a second surface.

8. The dental sanding strip of claim 7, wherein the abrasive portion is located on the first surface of the elongated strip.

9. The dental sanding strip of claim 7, wherein the second surface of the dental sanding strip is smooth.

10. The dental sanding strip of claim 1, wherein the elongated strip is a flexible film.

11. A method of removing material between teeth, the method comprising the steps of:
inserting an elongated filament of a dental sanding strip between teeth by first inserting a free end of the elongated filament into the space between the teeth;
grasping the elongated filament;
pulling the elongated filament thereby permitting an abrasive portion on the dental sanding strip to contact the area on a tooth; and
manipulating the dental sanding strip to remove any unwanted material between the teeth.

12. The method of claim 11, wherein the dental sanding strip is manipulated by gripping a holding portion on the dental sanding strip.

13. The method of claim 11, wherein the dental sanding strip is manipulated in a sawing motion to remove unwanted material between teeth.

14. The method of claim 11, wherein the dental sanding strip is manipulated in a circular motion to remove unwanted material between teeth.
